(19) United States
(12) Patent Application Publication
(10) Pub. No.: US 2007/0089133 A1
(43) Pub. Date: Apr. 19, 2007

(54) Method of displaying electronic program information

(76) Inventor: Yueh-Chiang Hou, Gueishan Township (TW)

Correspondence Address: BIRCH STEWART KOLASCH & BIRCH, PO BOX 747, FALLS CHURCH, VA, 22040-0747, US

(21) Appl. No.: 11/249,438

(22) Filed: Oct. 14, 2005

(51) Int. Cl. G06F 13/00; H04N 5/445; G06F 3/00

(52) U.S. Cl. 725/40; 725/39; 725/44

(57) ABSTRACT

A method of displaying electronic program information includes the steps of (a) using a video converter to receive or transmit information about programs to be played over at least one channel and stored in a video server linked to the video converter; and (b) using the video converter to show the program information in a corresponding zone on a display linked thereto in a reminding form, such that some part of the program information that had been shown for a predetermined period of time and then went out of sight from the display is shown again for another predetermined period of time.

### FIELD OF THE INVENTION

The present invention relates to a method of displaying electronic program information, and more particularly to method of displaying electronic program information that allows a user to use simplified operating procedures to preview information about programs to be played.

### BACKGROUND OF THE INVENTION

Thanks to the highly developed technologies, diverse ways of showing information about the services provided by different media are available now. In the era flooded with information, it has become an important issue to work out an efficient, simple, and definite way for showing the diverse service information, so that users may access what service they really need. Meanwhile, there is still another important issue to provide an operational interface for users to conveniently browse the services they need. Most of the currently available information transmitting systems, satellite or ground broadcasting systems, and cabled television systems are able to provide diversified services. A “Digital Set Top Box” (D-STB) is an access point for these services. With an electronic program guide (EPG) provided by the D-STB, users may conveniently and easily select the services they need.

To provide the currently available electronic program guide, a provider has to classify all the programs based on their contents, and show the classified types and the program names corresponding to the types on a sheet of paper or directly on a display or screen via which consumers watch the programs, so as to provide consumers with a brief description, the cast, etc. of every program to be played.

Please refer to FIG. 1 that is a block diagram showing a system structure of a conventional electronic program guide, and to FIGS. 2, 3, and 4 that are three pictures shown corresponding to the operation of the system. When a consumer wants to view information about the programs to be played over a certain channel when the screen is in a displaying state, a Film Type frame P11 (see FIG. 2) previously stored in the memory P177 of a video converter P17 (see FIG. 1) could be shown on a display P10. The film Type frame P11 further includes a Film Type menu P13, which includes a “Type No.” column P133 showing a series of numbers, such as 1, 2, 3, and so on, and a “Type Name” column P135 showing different film types, such as Affectional film, Kung-Fu film, Comedy film, etc., corresponding to the numbers shown in the “Type No.” column P133. The Film Type frame P11 and the Film type menu P13 are stored in a program databank P23 of a video server P20 (see FIG. 1), and are pre-stored in the memory P177 through functioning of a video controller P21 in the video server P20, a first link P27, and a video receiver P171 and an internal signal processor P175 in the video converter P17.

Please refer to FIGS. 1 and 2 at the same time. In a first step of operating the above-structured conventional electronic program guide system, the consumer may control a Number key P31, a Direction key P35, or a Remote Control key P33 on a program selector P30, so as to inform the video converter P17 of a desired Type Name row P131 via a second link P375, and make the selected Type Name row P131 a marked Type Name row P137, such as the Kung-Fu film corresponding to Type No. 2.

Please refer to FIGS. 1 and 3 at the same time. In a second step of operating the above-structured conventional electronic program guide system, the display P10 automatically shows a Program Description frame P15, which includes a Program Menu P150 having a plurality of Program Name rows P151. Each of the Program Name rows P151 includes a program serial number P153, such as 1, 2, 3, etc., and a program name P155 corresponding to the program serial number P153. Of course, each of the Program Name rows P151 may further include a program description box P158 to show a brief description, the cast, the duration, and the start time of the program. The consumer may control the program selector P30 or keys P103 on the display P10 in order to inform the video converter P17 of a desired Program Name row P151, and make the desired Program Name row P151 as a marked Program Name row P157, such as the film “Crouching Tiger and Hidden Dragon” corresponding to the program serial number 1.

Please refer to FIGS. 1 and 4 at the same time. In a third step of operating the above-structured conventional electronic program guide system, the consumer may select whether to continue the electronic program guide or not. If not, the consumer exits and ends the system; and if yes, the consumer may go to a fourth step, in which the consumer may decide whether to view information about other programs in the same film type or not. If the consumer's decision is yes, he or she may return to the step 2 to view desired Program Name rows P151 and the preview P181 of a desired program corresponding to a marked Program Name row P157. And, if the consumer's decision is No, the system returns to the step 1 and the consumer may select another desired Type Name row P131.

The above-structured conventional program guide system has the following disadvantages:
1. In the process of selecting a desired program or film, the consumer has to repeatedly enter the Film Type menu P13 and then select a marked Program Name row P157 to show information about the desired program.
2. The preview of a program can be shown only when a marked Program Name row P157 has been selected. And, the Program Name column and the Program Description box are the only information based on which the consumer selects the desired program. That is, the preview of a program does not provide a significant program bulletin effect.
3. It is impossible to view other program name rows P151 when the preview of a certain program is being displayed. The consumer has to return to and repeat some previous steps to view other program name rows.

Therefore, the conventional electronic program guide system includes complicate procedures and is not convenient for use, and must be improved to overcome the above-mentioned disadvantages.

### SUMMARY OF THE INVENTION

A primary object of the present invention is to provide a method of displaying electronic program information, with which diverse service information could be shown in an efficient, simple, and clear way for users to access the service they really need.

Another object of the present invention is to provide a method of displaying electronic program information that simplifies the operating procedures for a user to preview information of a desired program.

A further object of the present invention is to provide a method of displaying electronic program information, in which at least part of the program information that had been shown for a predetermined period of time and then went out of sight from a display could be shown again for another predetermined period of time in a reminding form, so that areas occupied by the program information on the display could be reduced and users do not have to frequently switch the picture on the display.

A still further object of the present invention is to provide a method of displaying electronic program information, in which brief electronic information about the programs to be played over every channel is shown in a corresponding data display zone on a display; and whenever one data displaying zone is selected and marked, the more detailed contents of the corresponding channel is displayed in the data display zone.

To achieve the above and other objects, the method of displaying electronic program information according to the present invention mainly includes the steps of (a) using a video converter to receive and transmit information of programs to be played over at least one channel stored in a video server linked to the video converter; and (b) using the video converter to show the program information in a corresponding zone on a display, which is linked to the video converter, so that at least part of the program information that had been shown for a predetermined period of time and then went out of sight from the display could be shown again for another predetermined period of time in a reminding form.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional electronic program guide system;

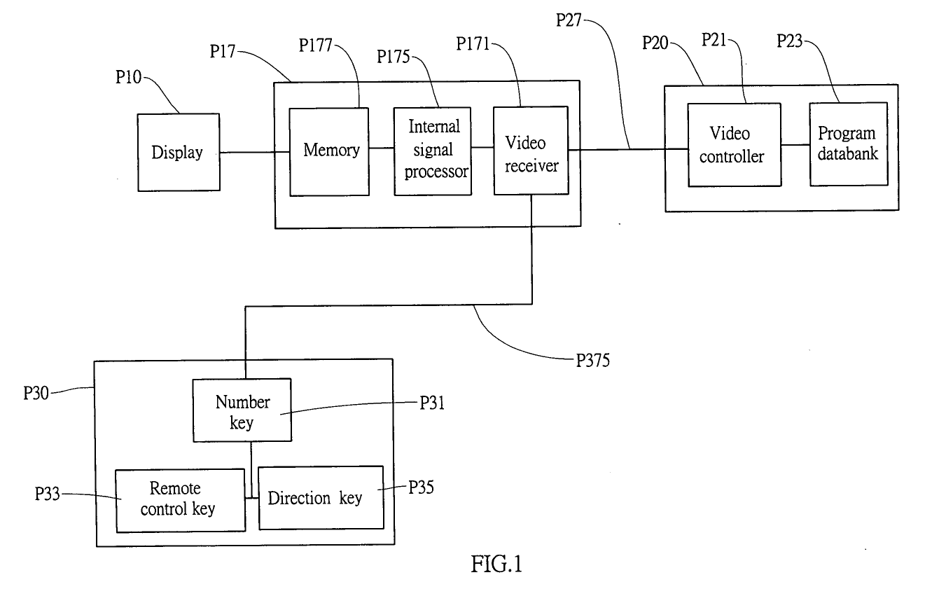

FIG. 2 shows a first picture shown corresponding to the operation of the conventional electronic program guide system of FIG. 1;

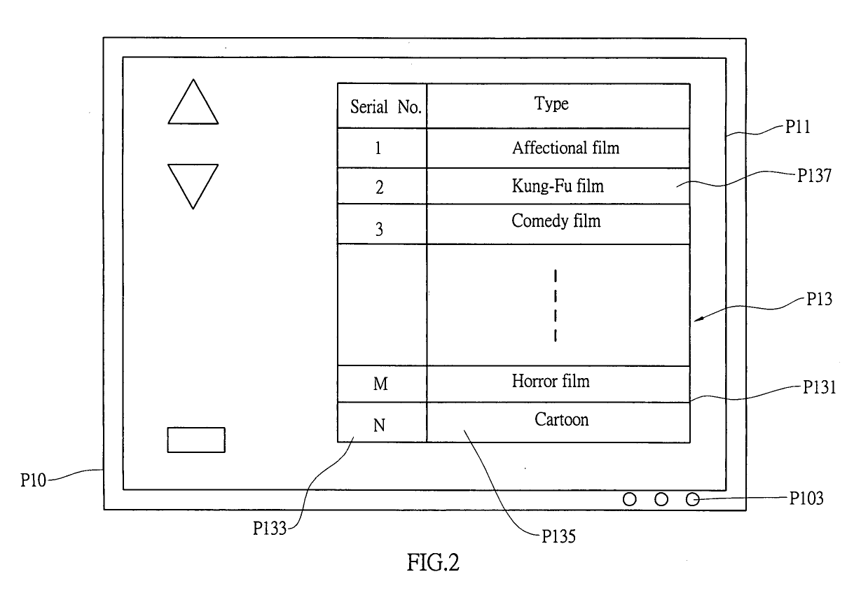

FIG. 3 shows a second picture shown corresponding to the operation of the conventional electronic program guide system of FIG. 1;

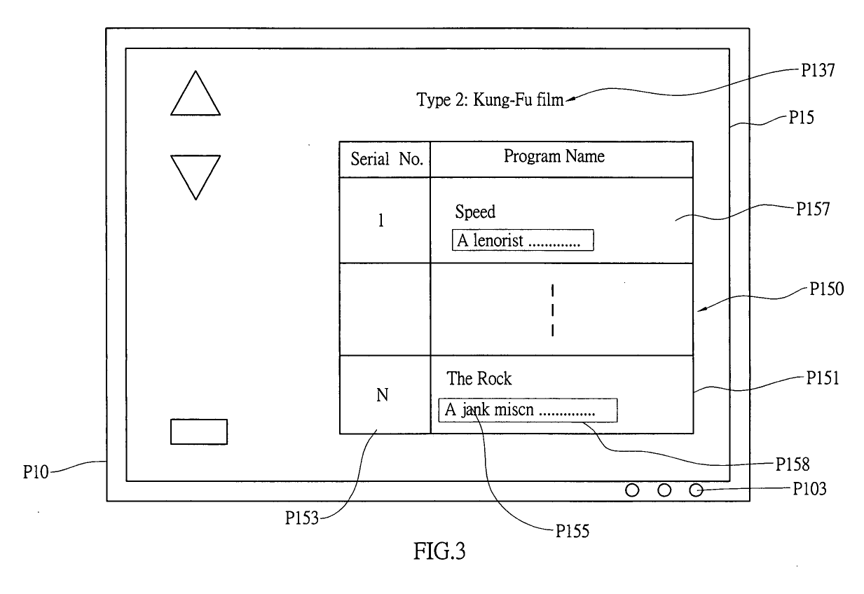

FIG. 4 shows a third picture shown corresponding to the operation of the conventional electronic program guide system of FIG. 1;

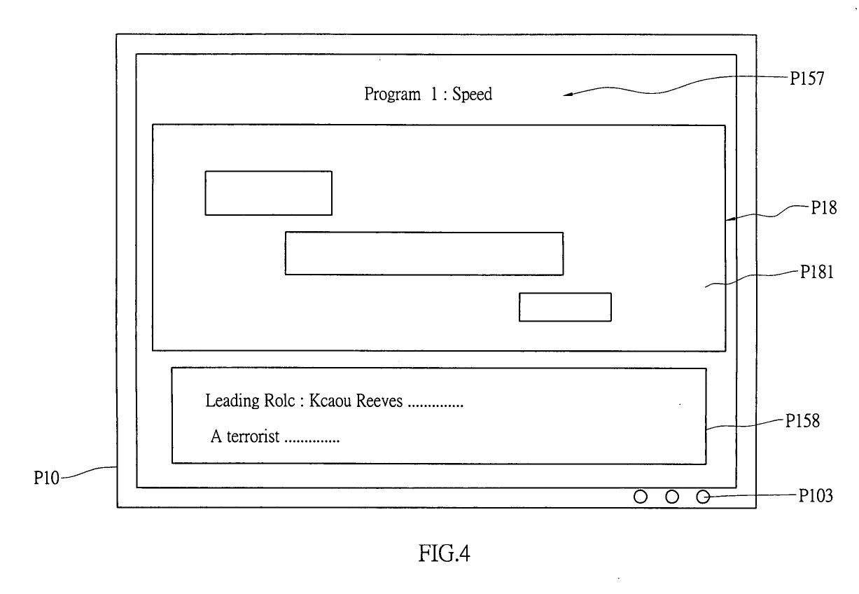

FIG. 5 is a block diagram showing a preferred embodiment of the present invention;

FIG. 6 is a first picture shown corresponding to the operation of the present invention shown in FIG. 5;

FIG. 7 is a second picture shown corresponding to the operation of the present invention shown in FIG. 5; and

FIG. 8 is a flowchart showing the steps included in the present invention.

### DETAILED DESCRIPTION OF THE PREFERRED EMBODIMENTS

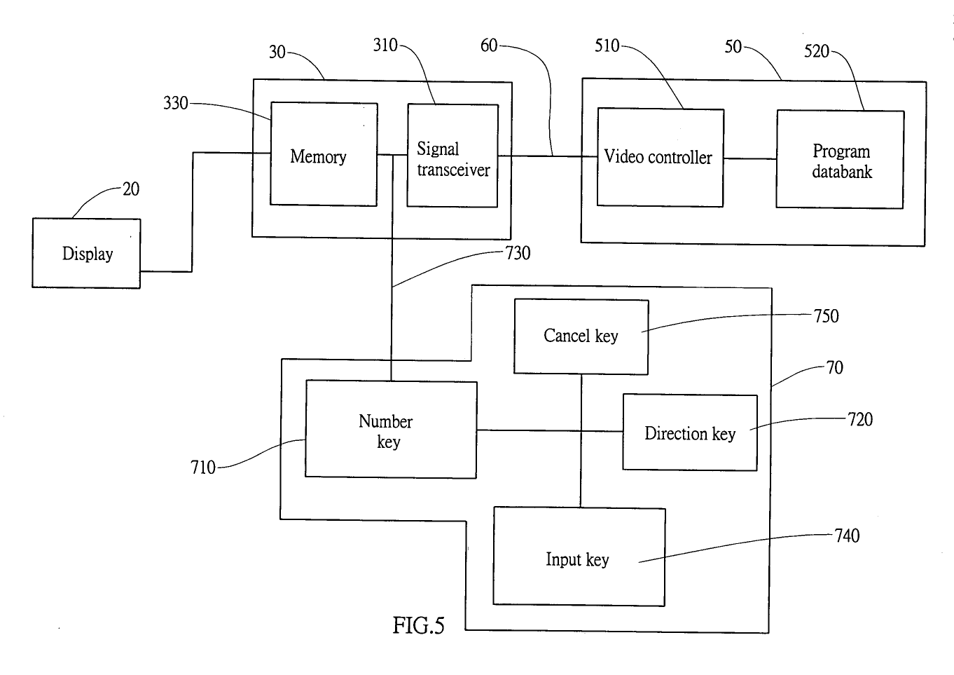

Please refer to FIG. 5 that is a block diagram showing a system structure for implementing a method of displaying electronic program information according to an operable embodiment of the present invention. As shown, the system structure for implementing the present invention includes a display 20, a video converter 30 linked to the display 20, a video server 50, a first link 60, and a program selector 70.

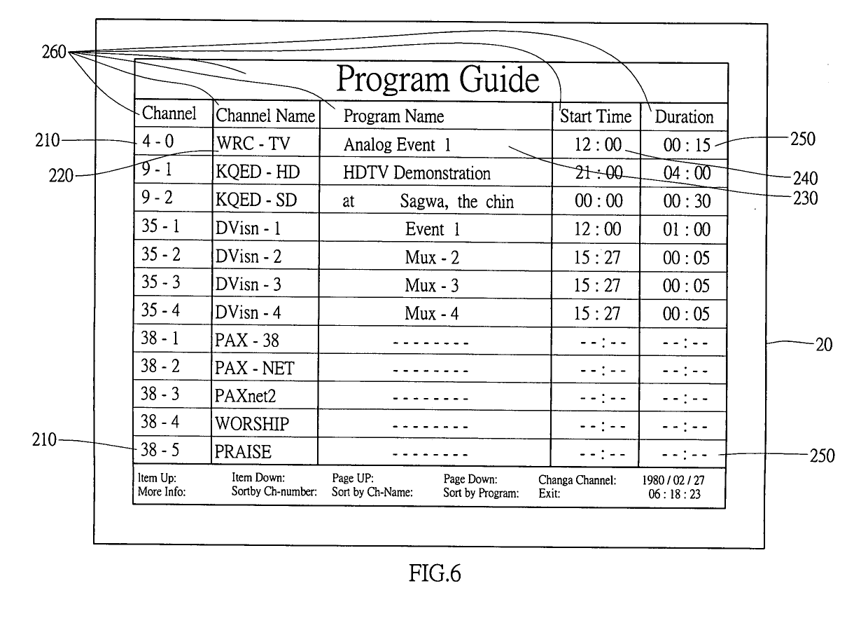

Please refer to FIG. 6. The display 20 includes a Channel Number zone 210, a Channel Name zone 220, a Program Name zone 230, a Start Time zone 240, a Duration zone 250, and a program guide information zone 260.

The video converter 30 is linked to the display 20 in a wired or a wireless manner to receive or transmit information of programs to be played over at least one channel. The program information mainly includes a Channel Number field, a Channel Name field, a Program Name field, a Start Time field, and a Duration field. Information shown in these fields are correspondingly transmitted by the video converter 30 to the Channel Number zone 210, the Channel Name zone 220, the Program Name zone 230, the Start Time zone 240, and the Duration zone 250 on the display 20 for users to know information about the programs they want to view.

The program selector 70 may be a wired selector, or a wireless remote controller, or a device set up on the display 20. As can be seen from FIG. 5, the program selector 70 is provided with at least a Number key 710, a Direction key 720, an Input key 740, and a Cancel key 750. The program selector 70 is linked to the video converter 30 via a second link 730 in the case of a wired selector, so as to transmit the information about a selected channel to the video converter 30 or inform the video converter 30 of the information about a selected channel, such as the channel number, the channel name, the program name, the start time, the duration, and so on.

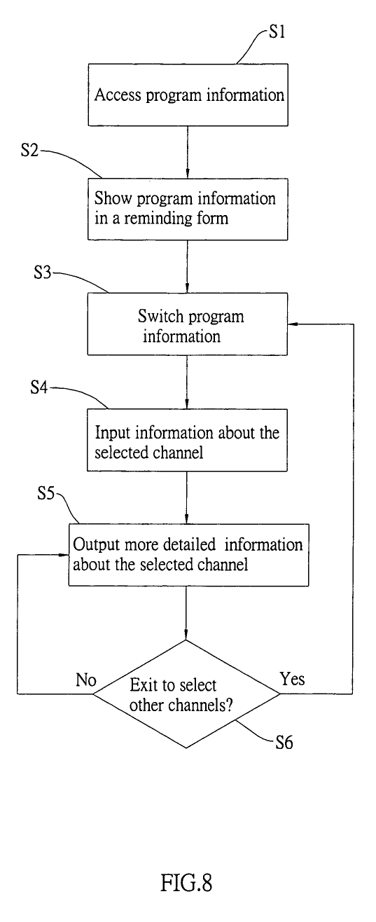

FIG. 8 is a flowchart showing the steps included in the method of displaying electronic program information according to a preferred embodiment of the present invention. Please refer to FIGS. 5, 6, 7, and 8 at the same time. In a first step S1 of the method of the present invention, for a user to view an electronic program guide (EPG) while the display 20 is in use, that is, in a displaying state, the contents to be shown on the display 20, such as the information about programs, are pre-stored in a program databank 520 in the video server 50 and can be accessed (that is, be received or transmitted) by a signal transceiver 310 in the video converter 30 via a video controller 510 in the video server 50 and the first link 60, which links the video server 50 to the video converter 30. However, in the case of a wireless connection between the video converter 30 and the video server 50, the first link 60 is omitted. The pre-stored program information includes the information about programs to be played over at least one channel, such as the channel number field, the channel name field, the program name field, the start time field, and the duration field.

In a second step S2 of the method of the present invention, the above-mentioned program information is shown by the video transceiver 310 in the video converter 30 in a corresponding zone on the display 20, which is linked to the video converter 30, such as the Channel Number zone 210, the Channel Name zone 220, the Program Name zone 230, the Start Time zone 240, and the Duration zone 250. The program information may be shown in different manners, including in a reminding form in which some part of the program information that had been shown for a predetermined period of time and then went out of sight from the display is shown again for another predetermined period of time, such as showing a circulating belt on the display 20 for continuously displaying the program information on the circulating belt. However, it is understood there are still other ways for reminding the user of the program information. In the above-mentioned reminding form of showing the program information, more detailed information about the programs to be played on every channel is shown. The program information may be stored in the memory 330 of the video converter 30.

In a third step S3 of the method of the present invention, a zone on the display 20 corresponding to a selected channel is designated as a marked zone by the video converter 30, and a user may control the program selector 70 linked to the video converter 30 to switch among different zones to designate a marked zone. That is, the user may control the Number key 710 and/or the Direction Key 720 to shift or switch to a desired marked zone. In the case of a wired program selector 70, information about a selected channel to be viewed, such as the channel number, the channel name, the program name, the start time, and the duration, is transmitted via the second link 730 to video converter 30. In the case of a program selector 70 set up on the display 20 or a wireless program selector 70, the information about the selected channel could be transmitted to the video converter 30 without the second link 730.

In a fourth step S4 of the method of the present invention, the Input key 740 on the program selector 70 is controlled to input the information about the selected channel, which corresponds to the marked zone on the display 20, to the video converter 30.

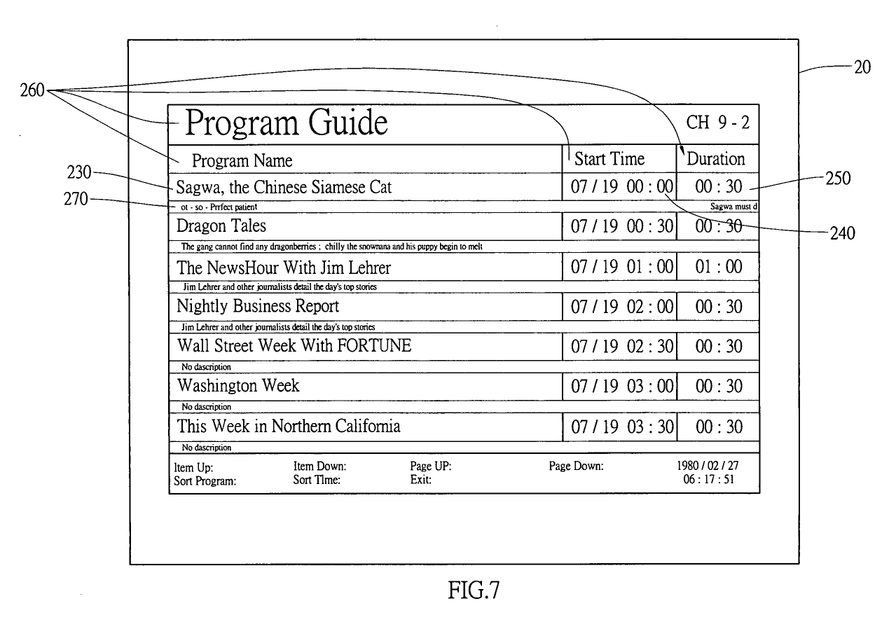

In a fifth step S5 of the method of the present invention, more detailed information about the selected channel, such as information shown in the Program Name field, the Start Time field, and the Duration field, that are stored in the program databank 520 in the video server 50, may be accessed (received and transmitted) by the signal transceiver 310 in the video converter 30, and transmitted to a corresponding zone 230, 240 or 250 on the display 20. In an operable embodiment of the present invention, the display 20 only shows the Program Name zone 230, the Start Time zone 240, and the Duration zone 250. In this case, the areas for these zones on the display 20 may be expanded to show more detailed information, as shown in FIG. 7. Again, the detailed program information could be shown in the above-mentioned reminding form, including showing a circulating belt on the display 20, so that at least part of the program information that had been shown for a predetermined period of time and then went out of sight from the display could be shown again for another predetermined period. In another embodiment of the present invention, a Description belt 270 may be shown between two adjacent rows of Program Name zone 230, Start Time zone 240, and Duration zone 250 to circulate the program information, as shown in FIG. 7. In this manner, the users may view different information about a program, such as a synopsis, the cast, the leading roles, and the type of the program.

In a final step S6 after the fifth step S5, the signal transceiver 310 in the video converter 30 detects whether the Cancel key 750 on the program selector 70 or a cancel key (not shown) on the display 20 is depressed by the user. If yes, the whole system would return to the third step S3 for the user to select and view information about other channels or programs.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of displaying electronic program information, comprising the steps of:
(a) Using a video converter to receive or transmit information about programs to be played over at least one channel, said program information being stored in a video server linked to said video converter; and
(b) Using said video converter to show said program information in a corresponding zone on a display linked to said video converter; and said program information being shown in a reminding form in which some part of said program information that had been shown for a predetermined period of time and then went out of sight from said display is shown again for another predetermined period of time.

2. The method of displaying electronic program information as claimed in claim 1, wherein said reminding form for showing said program information includes a circulating belt shown on said display for continuously displaying said program information on said circulating belt.

3. The method of displaying electronic program information as claimed in claim 1, wherein said reminding form of showing said program information shows only more detailed information about the programs to be played on said at least one channel.

4. The method of displaying electronic program information as claimed in claim 1, further comprising a step (c) after the step (b) to use said video converter to designate a zone on said display corresponding to a selected channel as a marked zone, and to control a program selector linked to said video converter to switch among different zones on said display to designate a marked zone, and to transmit information about a selected channel to be viewed to said video converter.

5. The method of displaying electronic program information as claimed in claim 4, further comprising a step (d) after the step (c) to control said program selector in order to input information about said selected channel, which corresponds to said designated marked zone on said display, to said video converter.

6. The method of displaying electronic program information as claimed in claim 5, further comprising a step (e) after the step (d) to allow said video converter to access more detailed information about said selected channel that is stored in said video server.

7. The method of displaying electronic program information as claimed in claim 6, wherein said more detailed information about said selected channel accessed by said video converter is transmitted to said corresponding zone on said display by said video converter.

8. The method of displaying electronic program information as claimed in claim 7, wherein said more detailed information about said selected channel is shown in said reminding form, so that at least part of said more detailed information that had been shown for a predetermined period of time and then went out of sight from said display is shown again for another predetermined period.

9. The method of displaying electronic program information as claimed in claim 8, wherein said more detailed information about said selected channel shown in said reminding form is displayed on a circulating belt shown on said display.
